(19) United States
(12) Patent Application Publication
(10) Pub. No.: US 2015/0127570 A1
(43) Pub. Date: May 7, 2015

(54) AUTOMATIC ACCIDENT REPORTING DEVICE

(71) Applicant: HTI IP, LLC, Atlanta, GA (US)

(72) Inventors: John Doughty, Atlanta, GA (US); Eric Berkobin, Woodstock, GA (US)

(73) Assignee: HTI IP, LLC, Atlanta, GA (US)

(21) Appl. No.: 14/071,763

(22) Filed: Nov. 5, 2013

(51) Int. Cl. G06Q 50/26; G06Q 10/00

(52) U.S. Cl. CPC G06Q 50/265; G06Q 10/00
USPC 705/325

(57) ABSTRACT

A device is configured to receive vehicle information associated with a vehicle, and determine that the vehicle has been in an accident based on the vehicle information. The device is configured to generate an accident report based on determining that the vehicle has been in the accident and based on the vehicle information. The device is configured to provide the accident report for display, and to receive a confirmation that the accident report is accurate based on providing the accident report for display. The device is configured to output the accident report based on receiving the confirmation.

### BACKGROUND

A vehicle (e.g., an automobile) may be associated with a telematics device. The telematics device may gather information associated with the vehicle, such as information associated with a movement of the vehicle, a status of the vehicle, an operation of the vehicle, or the like.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for automatically generating and providing an accident report;

FIGS. 5A-5B are diagrams of an example implementation relating to the example process shown in FIG. 4;

FIGS. 6A-6D are diagrams of another example implementation relating to the example process shown in FIG. 4; and

FIGS. 7A-7D are diagrams of yet another example implementation relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

A vehicle (e.g., an automobile) may be involved in an accident (e.g., a collision) with an object (e.g., a tree, a building, a person, another vehicle, a telephone pole, etc.). An emergency responder (e.g., a police officer) may visit the scene of the accident, and may prepare an accident report. However, the process of gathering information necessary for the accident report may be time consuming and/or time sensitive. For example, the emergency responder may need to travel to a scene of the accident, view vehicles and objects involved in the accident, speak to drivers of the vehicles, interview witnesses, or the like. Additionally, people (e.g., witnesses, drivers, passengers, etc.) may leave the scene of the accident, may move a vehicle involved in the accident, etc. In some instances, waiting for the emergency responder to gather the information necessary for the accident report may cause delays for people associated with the accident (e.g., people involved in the accident, people traveling near the accident, etc.). Implementations described herein may allow a telematics server device and/or other device (e.g., one or more telematics devices, one or more telematics devices associated with one or more vehicles, one or more telematics devices working with a telematics server device, etc.) to automatically determine that a vehicle has been involved in an accident and generate an accident report based on vehicle information associated with the vehicle.

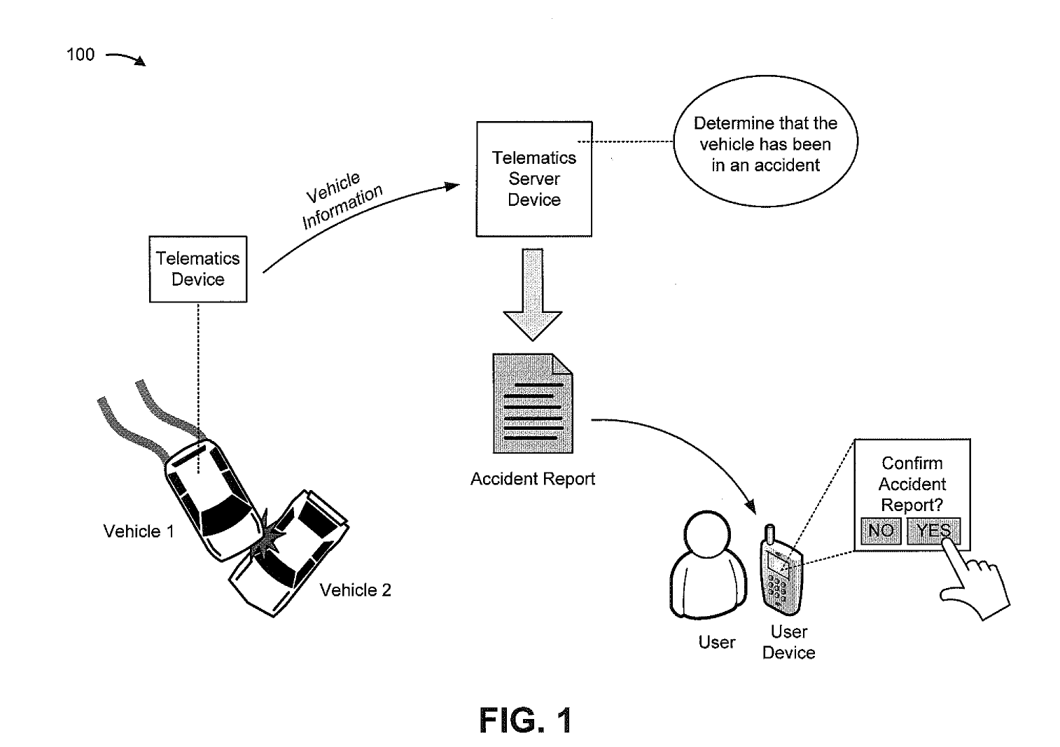

FIG. 1 is a diagram of an overview of an example implementation 100 described herein. As shown in FIG. 1, example implementation 100 may include two vehicles (e.g., a first vehicle and a second vehicle), a telematics device, a telematics server device, and a user device.

As shown in FIG. 1, the first vehicle (e.g., “Vehicle 1”) may be associated with the telematics device. The telematics device may gather vehicle information associated with the first vehicle. The vehicle information may include information that identifies a state of the first vehicle (e.g., a speed of the first vehicle, an acceleration of the first vehicle, a location of the first vehicle, etc.). Assume that the first vehicle is involved in an accident with the second vehicle (e.g., “Vehicle 2”). The telematics device may provide the vehicle information to the telematics server device.

As further shown in FIG. 1, the telematics server device may determine that the first vehicle has been in the accident based on the vehicle information (e.g., based on determining that the first vehicle has rapidly decelerated). Based on determining that the first vehicle has been in the accident and based on the vehicle information, the telematics server device may generate an accident report. The telematics server device may provide the accident report to a user device associated with a user (e.g., a driver of the first vehicle). The user may view the accident report, and may confirm that the accident report is accurate. Based on receiving the confirmation that the accident report is accurate, the telematics server device may provide some or all of the accident report to a device associated with an interested third party (e.g., an insurance company, a law enforcement agency, a vehicle towing company, etc.). In this manner, the telematics device, the telematics server device, and/or a combination of the telematics device and telematics server device may automatically generate and provide the accident report based on the vehicle information associated with the first vehicle.

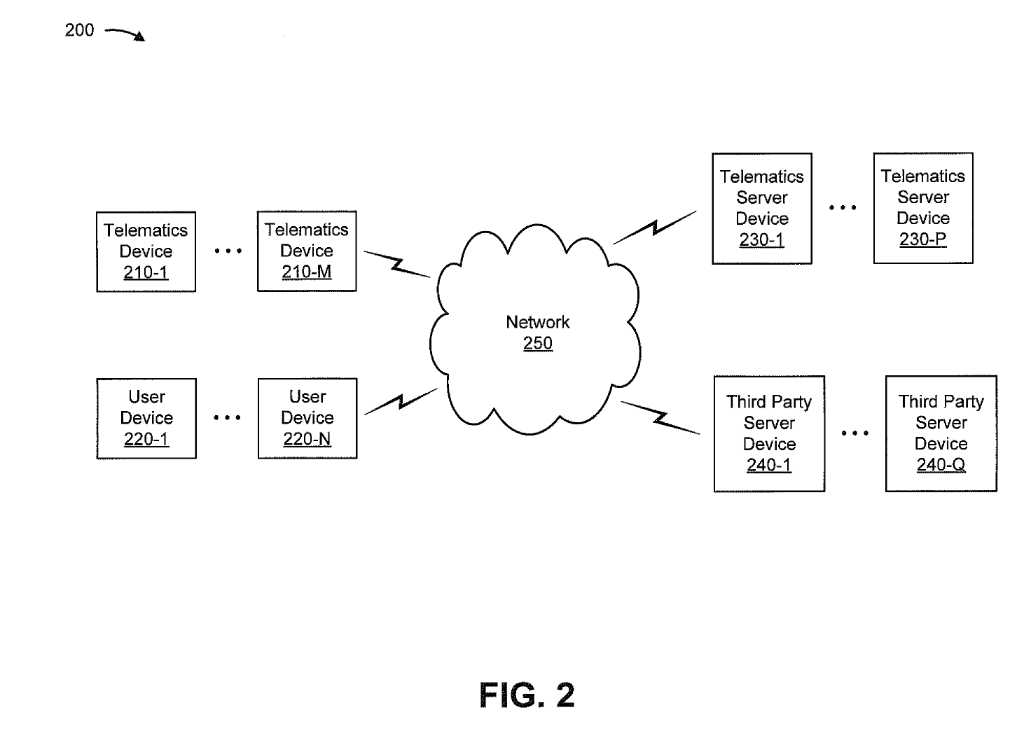

FIG. 2 is a diagram of an example environment 200 in which systems and/or methods described herein may be implemented. As shown in FIG. 2, environment 200 may include telematics devices 210-1 . . . 210-M (M≧1) (hereinafter referred to collectively as “telematics devices 210,” and individually as “telematics device 210”), user devices 220-1 . . . 220-N (N≧1) (hereinafter referred to collectively as “user devices 220,” and individually as “user device 220”), telematics server devices 230-1 . . . 230-P (P≧1) (hereinafter referred to collectively as “telematics server devices 230,” and individually as “telematics server device 230”), third party server device 240-1 . . . 240-Q (Q≧1) (hereinafter referred to collectively as “third party server devices 240,” and individually as “third party server device 240”), and a network 250. Devices of environment 200 may interconnect via wired connections, wireless connections, or a combination of wired and wireless connections.

Telematics device 210 may include a device capable of receiving, processing, storing, and/or providing information, such as information associated with a vehicle. For example, telematics device 210 may include a computing device (e.g., a laptop computer, a handheld computer, a component of a vehicle diagnostic or control system, etc.), a mobile telephone, an accelerometer, or a similar device. In some implementations, telematics device 210 may be associated with a camera (e.g., a video camera, a web camera, etc.), a microphone, or a similar device. In some implementations, telematics device 210 may be associated with a vehicle. For example, telematics device 210 may connect to a diagnostic system associated with the vehicle, a control system associated with the vehicle, or the like (e.g., via a wired and/or wireless connection). The camera, or cameras, and/or microphone, may be fixed to the vehicle, and may provide content via the vehicle's communication bus (e.g., a control area network (“CAN”) bus) to telematics device 210. Telematics device 210 may receive information from and/or transmit information to user device 220, telematics server device 230, and/or third party server device 240.

User device 220 may include a device capable of receiving, storing, processing, and/or transmitting information, such as information associated with a vehicle and/or information associated with an accident report. For example, user device 220 may include a mobile telephone (e.g., a cellular telephone, a smartphone, etc.), a computing device (e.g., a desktop computer, a laptop computer, a tablet computer, a handheld computer, etc.), or a similar device. In some implementations, user device 220 and telematics device 210 may be implemented together within a single device. User device 220 may receive information from and/or transmit information to telematics device 210, telematics server device 230, and/or third party server device 240.

In some implementations, the functionality of telematics device 210 may be distributed between telematics device 210 and user device 220. For example, telematics device 210 may couple to a communication bus of a vehicle by use of a hardware key (e.g., a dongle) to acquire vehicle information. The hardware key may include a device capable of unlocking software functionality and/or decoding content associated with a computing device (e.g., the communication bus). In some implementations, the hardware key may be installed in the vehicle, and may couple directly to the communication bus. Additionally, or alternatively, the hardware key may couple to the vehicle by use of a diagnostic connection, such as an onboard diagnostic (“OBD”) device (e.g., via an OBD-II port). Telematics device 210 (e.g., associated with the hardware key) may provide vehicle information via a long range wireless link to a remote server (e.g., such as telematics server device 230). Additionally, or alternatively, telematics device 210 may transmit the vehicle information over a short range wireless link, such as Bluetooth® (which is a registered trademark of Bluetooth SIG), to user device 220 (e.g., a smartphone), and user device 220 may transmit the vehicle information over a long range wireless link to the remote server (e.g., telematics server device 230). In such a distributed telematics device scenario, information processing and telematics applications may run on user device 220, and telematics device 210 may function mainly as a conduit of vehicle information from the vehicle to user device 220.

Telematics server device 230 may include a device capable of receiving, storing, processing, and/or transmitting information, such as information associated with a vehicle and/or information associated with an accident report. For example, telematics server device 230 may include a computing device, such as a server, a desktop computer, a laptop computer, a tablet computer, a handheld computer, or a similar device. Telematics server device 230 may receive information from and/or transmit information to telematics device 210, user device 220, and/or third party server device 240.

Third party server device 240 may include one or more devices capable of receiving, storing, processing, and/or transmitting information, such as information associated with an accident report. For example, third party server device 240 may include a computing device, such as a server, a desktop computer, a laptop computer, a tablet computer, a handheld computer, a mobile telephone, or a similar device. Additionally, or alternatively, third party server device 240 may receive information from and/or transmit information to telematics device 210, user device 220, and/or telematics server device 230.

Network 250 may include one or more wired and/or wireless networks. For example, network 250 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, or a combination of these or other types of networks.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

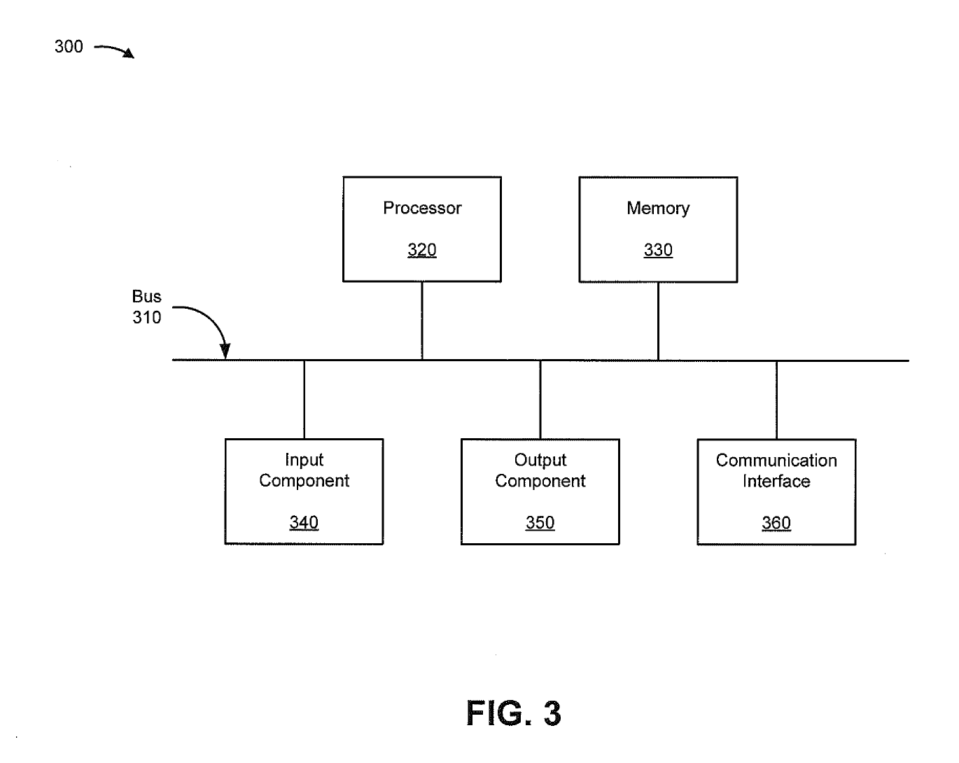

FIG. 3 is a diagram of example components of a device 300. Device 300 may correspond to telematics device 210, user device 220, telematics server device 230, and/or third party server device 240. Additionally, or alternatively, each of telematics device 210, user device 220, telematics server device 230, and/or third party server device 240 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

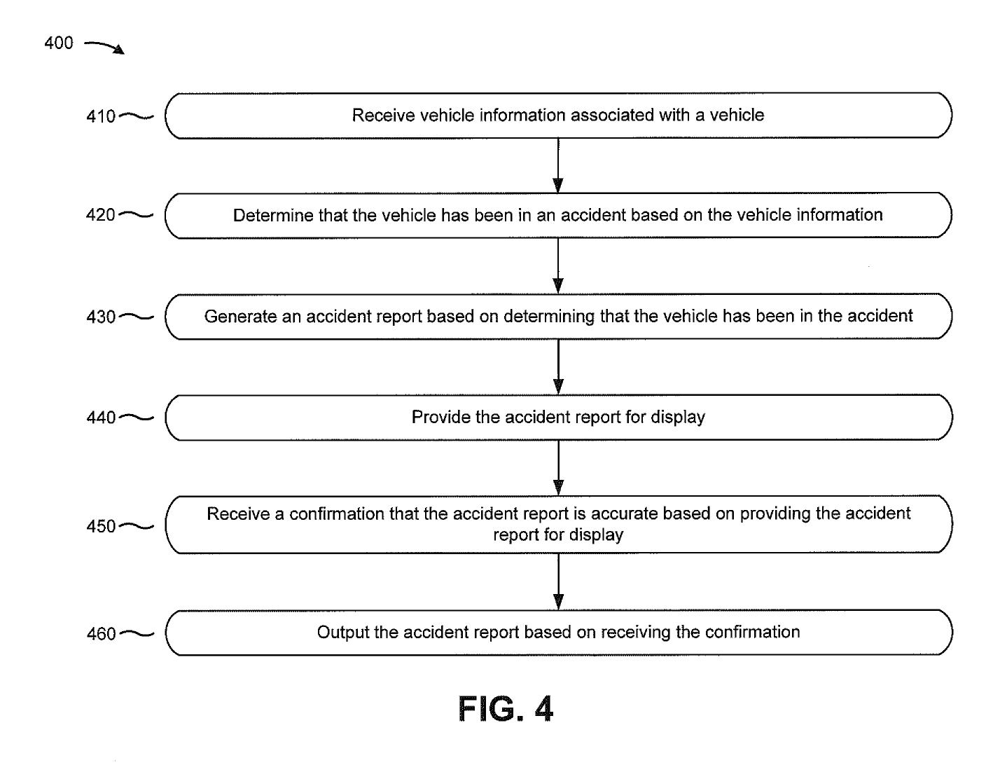

FIG. 4 is a flow chart of an example process 400 for automatically generating and providing an accident report. In some implementations, one or more process blocks of FIG. 4 may be performed by telematics server device 230. Additionally, or alternatively, one or more process blocks of FIG. 4 may be performed by another device or a group of devices separate from or including telematics server device 230, such as telematics device 210, user device 220, and/or third party server device 240.

As shown in FIG. 4, process 400 may include receiving vehicle information associated with a vehicle (block 410). For example, telematics server device 230 may receive the vehicle information from a particular telematics device 210 associated with the vehicle. In some implementations, telematics server device 230 may receive vehicle information associated with multiple vehicles. For example, a first vehicle may be associated with a first telematics device 210-1, and a second vehicle may be associated with a second telematics device 210-2. Telematics server device 230 may receive first vehicle information from first telematics device 210-1, and may receive second vehicle information from second telematics device 210-2.

In some implementations, the vehicle information may include information that identifies a state of the vehicle. For example, the vehicle information may include information that identifies an operation of the vehicle, a condition of the vehicle, or the like.

In some implementations, the vehicle information may include information that identifies the vehicle. For example, the vehicle information may include a vehicle identifier (e.g., a vehicle identification number (“VIN”), a license plate state and number, etc.), a make of the vehicle, a model of the vehicle, or the like.

In some implementations, the vehicle information may include information that identifies a movement of the vehicle. For example, the vehicle information may identify a speed of the vehicle, a direction of the vehicle, whether the vehicle is accelerating, whether the vehicle is decelerating, or the like. In some implementations, telematics device 210 may be associated with an accelerometer, and the vehicle information may include information that identifies movements determined by the accelerometer (e.g., acceleration, deceleration, turning, rotating, etc.). Additionally, or alternatively, the vehicle information may include information that identifies a geographic location of the vehicle. For example, the vehicle information may identify a geographic location (e.g., a latitude and longitude) based on a global positioning system (“GPS”) or a navigation system.

In some implementations, the vehicle information may include information that identifies a status associated with one or more components of the vehicle. For example, the vehicle information may identify an extent to which a pedal is depressed (e.g., an accelerator pedal, a brake pedal, etc.), a degree to which a steering wheel is turned, a rotational speed of one or more wheels, a particular gear used to drive the vehicle, or the like. Additionally, or alternatively, the vehicle information may identify whether headlamps are on, whether windshield wipers are on, whether a stereo is on, a volume setting associated with the stereo, or the like. In some implementations, the vehicle information may identify whether an airbag has deployed, whether an anti-lock breaking system has engaged, whether a warning system has alarmed (e.g., a lane departure warning system, a traction control system, a reverse backup warning system, etc.), or the like.

In some implementations, the vehicle may be associated with a device capable of measuring strain associated with one or more components of the vehicle (e.g., a strain gauge), and the vehicle information may include information that identifies a strain measurement associated with the one or more components. For example, a body of the vehicle may be associated with a set of strain gauges. The vehicle information may include information that identifies a deformation of the body, as measured by the set of strain gauges, associated with a collision of the vehicle.

In some implementations, the vehicle may be associated with a camera. For example, the vehicle may be associated with one or more cameras configured to view areas inside and/or outside of the vehicle (e.g., a dashboard camera, a backup camera, a front facing camera, a camera configured to obtain a side view outward from the vehicle, etc.). The vehicle information may include images captured with the one or more cameras, (e.g., pictures, videos, etc.), such as, for example, images of skid marks, objects, a condition and position of objects relative to the vehicle, weather conditions before an accident, during an accident, and/or after an accident, or the like. Additionally, or alternatively, the vehicle may be associated with a microphone, and the vehicle information may include audio associated with the microphone (e.g., an audio recording of sounds in a cabin of the vehicle).

In some implementations, telematics device 210 may determine the vehicle information by use of an on-board diagnostics (“OBD”) system associated with the vehicle. For example, telematics device 210 may connect to the OBD system via a diagnostic connector, and may receive vehicle information associated with one or more on-board computing devices associated with the vehicle. In some implementations, telematics device 210 may determine the vehicle information by use of one or more OBD parameter identifiers (e.g., OBD-II Parameter IDs). For example, telematics device 210 may request vehicle information, from the one or more on-board computing devices associated with the vehicle, by use of the OBD parameter identifiers. In some implementations, the OBD-II parameter IDs may be defined by a society of automotive engineers (“SAE”) standard, such as SAE J1979.

In some implementations, telematics device 210 may gather the vehicle information (e.g., from the vehicle), and may provide the vehicle information to telematics server device 230 (e.g., via network 250). Additionally, or alternatively, telematics device 210 may provide the vehicle information to user device 220 by use of a wireless connection (e.g., a Bluetooth connection, a WiFi connection, etc.). In these implementations, user device 220 may receive the vehicle information (e.g., via the wireless connection), and may provide the vehicle information to telematics server device 230 (e.g., via network 250).

In some information, telematics device 210, user device 220, and/or telematics server device 230 may store the vehicle information in a data structure (e.g., associated with telematics device 210, user device 220, and/or telematics server device 230). In some implementations, telematics device 210, user device 220, and/or telematics server device 230 may store a history of vehicle information. The history of vehicle information may include vehicle information associated with a past duration of time (e.g., an hour, a day, a week, etc.). In some implementations, the history of vehicle information may include a most recent duration of time (e.g., a most recent 10 minutes, a most recent hour, a most recent day, etc.).

As further shown in FIG. 4, process 400 may include determining that the vehicle has been in an accident based on the vehicle information (block 420). For example, telematics server device 230 may determine that the vehicle has been in the accident based on vehicle information gathered by telematics device 210.

In some implementations, the accident may include a collision associated with the vehicle (e.g., a collision between the vehicle and an object, a collision between the vehicle and another vehicle, etc.), a malfunction of the vehicle, or the like. In some implementations, telematics device 210 may determine that the vehicle has been in the accident based on information associated with an accelerometer (e.g., associated with telematics device 210). For example, telematics device 210 may determine that the vehicle has been in the accident based on movements determined by the accelerometer (e.g., a change in speed, a change in acceleration, a change in direction, etc.).

In some implementations, telematics server device 230 may determine that the vehicle has been in an accident based on determining that the vehicle has experienced a change in speed (e.g., a deceleration) consistent with a collision. For example, telematics server device 230 may determine that the vehicle is associated with a particular deceleration based on information gathered by an accelerometer (e.g., associated with telematics device 210). Telematics server device 230 may determine that the vehicle has been in the accident based on determining that the particular deceleration is greater than a threshold deceleration.

In some implementations, telematics server device 230 may determine that the vehicle has been in an accident based on determining that the vehicle has experienced a change in direction consistent with a collision (e.g., that the vehicle has flipped, spun, rolled, etc.). For example, telematics server device 230 may determine that the vehicle is associated with a particular change in direction based on information gathered by an accelerometer (e.g., associated with telematics device 210). Telematics server device 230 may determine that the vehicle has been in the accident based on determining that the particular change in direction is greater than a threshold change in direction.

In some implementations, telematics server device 230 may determine that the vehicle has been in an accident based on determining that an airbag associated with the vehicle has deployed. Additionally, or alternatively, telematics server device 230 may determine that the vehicle has been in an accident based on determining that a safety system has been activated (e.g., an anti-lock breaking system, a lane departure warning system, a traction control system, a reverse backup warning system, etc.). In some implementations, telematics server device 230 may determine that the vehicle has been in an accident based information associated with one or more strain gauges associated with a body of the vehicle. For example, telematics server device 230 may determine that the vehicle has been in an accident based on determining that the body has been deformed (e.g., due to a collision).

In some implementations, telematics server device 230 may determine that the vehicle has been in an accident based on user input. For example, a user of telematics device 210 and/or user device 220 (e.g., a driver of the vehicle, a passenger of the vehicle, an emergency responder, etc.) may provide user input to telematics device 210 and/or user device 220 indicating that the vehicle has been in an accident. Telematics device 210 and/or user device 220 may provide the user input to telematics server device 230, and telematics server device 230 may determine that the vehicle has been in an accident based on the user input.

In some implementations, one of the above factors may be used alone to determine that the accident has occurred. Alternatively, a combination of the above factors may be used to determine that the accident has occurred. In some implementations, telematics server device 230 may determine that the accident has occurred based on weighting the above factors (e.g., based on determining that some factors may be more important to identifying an accident than other factors). For example, telematics server device 230 may determine that a first factor (e.g., an indication that the an airbag has deployed) may be more important to identifying an accident than a second factor (e.g., an indication that a lane departure warning system has alarmed), and may assign the first factor a greater weight than a weight assigned to the second factor. In some implementations, telematics server device 230 may determine that the accident has occurred based on determining that one or more weights, associated with one or more factors, are greater than a threshold weight (e.g., that a weight associated with a factor is greater than a threshold weight, that a sum of weights associated with a set of factors is greater than a threshold weight, etc.).

In some implementations, telematics server device 230 may determine that multiple vehicles are associated with the same accident. For example, based on first vehicle information (e.g., associated with a first vehicle) and second vehicle information (e.g., associated with a second vehicle), telematics server device 230 may determine that the first vehicle and the second vehicle are associated with the same accident (e.g., a single collision). In some implementations, telematics server device 230 may determine that the first vehicle and the second vehicle are associated with the same accident based on a time of the accident (e.g., that a collision determined from the first vehicle information occurred within a threshold time period of a collision determined from the second vehicle information), a location of the accident (e.g., that the first vehicle is located within a threshold distance of the second vehicle), a user input (e.g., indicating that the first vehicle and the second vehicle are associated with the accident), or the like.

As further shown in FIG. 4, process 400 may include generating an accident report based on determining that the vehicle has been in the accident (block 430). For example, telematics server device 230 may generate the accident report based on vehicle information associated with telematics device 210. Additionally, or alternatively, the accident report may be generated by telematics device 210, user device 220, and/or third party server device 240.

In some implementations, the accident report may include information associated with the accident, such as information associated with a vehicle involved in the accident, an object involved in the accident, a driver associated with the accident, or the like. For example, the accident report may include vehicle information at a time of the accident, prior to the accident, and/or following the accident.

In some implementations, the accident report may include information that identifies a movement of the vehicle. For example, the accident report may identify a speed of the vehicle, a location of the vehicle, a direction of travel for the vehicle, or the like. Additionally, or alternatively, the accident report may identify whether the vehicle was accelerating, decelerating, turning, or the like. In some implementations, the accident report may include information that identifies the movement of the vehicle for a period of time prior to the accident (e.g., 1 minute before the accident, 10 minutes before the accident, etc.). Additionally, or alternatively, the accident report may include information that identifies the movement of the vehicle for a period of time after the accident (e.g., 1 minute after the accident, 10 minutes after the accident, etc.).

In some implementations, the accident report may include information that identifies that a safety system, associated with the vehicle, was activated (e.g., that an airbag deployed, that an anti-lock breaking system engaged, that a lane departure warning system alarmed, that a traction control system engaged, that a reverse backup warning system alarmed, etc.). In some implementations, the accident report may include information that identifies a region of impact associated with the vehicle (e.g., determined based on one or more strain gauges associated with the vehicle).

In some implementations, the accident report may include a narrative description of the accident. For example, telematics server device 230 may generate text that describes events associated with the accident. Additionally, or alternatively, the accident report may include a diagram of the accident (e.g., depicting a movement, a position, a location, etc., of the vehicle and/or surrounding objects). In some implementations, the accident report may include a simulation (e.g., a computer simulation) of the accident. For example, telematics server device 230 may generate a simulation of the movements of the vehicle, damage experienced by the vehicle (e.g., associated with an impact region), or the like.

In some implementations, telematics server device 230 may generate an accident report associated with a single vehicle. Additionally, or alternatively, telematics server device 230 may generate an accident report based on multiple vehicles. For example, based on first vehicle information (e.g., received from a first telematics device 210-1 associated with a first vehicle) and second vehicle information (e.g., received from a second telematics device 210-2 associated with a second vehicle), telematics server device 230 may generate an accident report associated with the first vehicle and the second vehicle. In some implementations, telematics server device 230 may generate the accident report based on determining that the first vehicle and the second vehicle are associated with the same accident (e.g., that the first vehicle and the second vehicle have collided).

In some implementations, telematics server device 230 may determine that there is a discrepancy between information associated with the first vehicle and information associated with the second vehicle. For example, telematics server device 230 may generate an accident report based on first vehicle information (e.g., associated with the first vehicle) and second vehicle information (e.g., associated with the second vehicle). Based on the first vehicle information and the second vehicle information, telematics server device 230 may determine that a piece of information (e.g., an accident location, an accident time, a description of events, etc.) associated with the first vehicle differs from a corresponding piece of information associated with the second vehicle (e.g., telematics server device 230 may determine that the vehicles are associated with differing descriptions of the accident). In some implementations, based on determining the discrepancy, telematics server device 230 may identify the discrepancy in the accident report.

In some implementations, vehicle information from one or more vehicles involved in an accident may be used to recreate an accident report that conforms to a standard of an insurance industry and/or law enforcement agency. For example, GPS coordinates may be used to generate a graphical representation of a position, or positions, of one or more vehicles, on a road, including position within lanes or in an intersection. The graphical representation may be represented as a map and/or as lanes of a road and/or intersection, and may be obtained from mapping software running on telematics device 210, user device 220, telematics server device 230, and/or third party server device 240. The graphical representation may be inserted as a page of an accident report to show what happened leading up to the accident, what happened as one or more vehicles involved in the accident came to rest, or the like. In some implementations, the accident report may indicate positions of the vehicles relative to corresponding germane time stamps, such as, for example, time stamps associated with the operation of traffic control devices, information for which may be available to telematics device 210, user device 220, telematics server device 230, and/or third party server 240. In some implementations, images of tire skid marks may be obtained from one or more of the cameras discussed above and used to enhance the graphic representation of the trajectories of the vehicles involved in an accident. Additionally, or alternatively, road sensors, such as, for example, load cell signals from sensors embedded under a road, radio frequency identification (“RFID”) sensors embedded in a road and/or along a roadway, and/or cameras mounted along the roadway, may be available for assimilation with, or in lieu of, vehicle information from the vehicles involved in an accident, to generate, and/or enhance, the accident report and its accuracy (e.g., before providing the accident report for display).

As further shown in FIG. 4, process 400 may include providing the accident report for display (block 440). For example, telematics server device 230 may provide the accident report to telematics device 210, user device 220, and/or third party server device 240. In some implementations, telematics server device 230 may provide the accident report by use of email, short message service (“SMS”) text message, an application associated with user device 220, or the like.

In some implementations, server device 230 may provide the accident report to telematics device 210 (e.g., associated with a vehicle). Telematics device 210 may display the accident report on a user interface associated with the vehicle. A user of the vehicle (e.g., a driver, a passenger, etc.) may view the accident report via the user interface.

In some implementations, telematics server device 230 may provide the accident report to user device 220. User device 220 may display the accident report (e.g., on a user interface associated with user device 220). A user of user device 220 (e.g., a driver, a passenger, etc.) may view the accident report via the user interface. In some implementations, user device 220 may be associated with emergency response personnel (e.g., a police officer, a fireman, an emergency medical responder, etc.), and the emergency response personnel may view the accident report via user device 220.

In some implementations, telematics device 210, user device 220, and/or telematics server device 230 may provide the accident report to a device associated with another vehicle. For example, a first user device 220-1 (e.g., associated with a driver of a first vehicle), may provide the accident report to a second user device 220-2 (e.g., associated with the driver of a second vehicle).

In some implementations, telematics device 210, user device 220, and/or telematics server device 230, may provide a portion of the accident report (e.g., in lieu of a full accident report). For example, the portion of the accident report may include information associated with one or more parties involved in the accident, such as contact information associated with a party (e.g., a name, an address, a telephone number, an email address, etc.), insurance information associated with the party (e.g., information that identifies an insurance provider, insurance coverage, insurance policy information, etc.), or the like. In some implementations, telematics device 210, user device 220, and/or telematics server device 230, may provide the portion of the accident report based on determining that the full accident report is not to be provided (e.g., is not needed). For example, telematics server device 230 may determine that the full accident report is not needed based on user input (e.g., input from a driver, associated with telematics device 210, indicating that the full accident report is not necessary), based on a severity of the accident (e.g., based on determining that a severity of the accident is less than a threshold severity to warrant a full accident report), or the like. Additionally, or alternatively, telematics server device 230 may provide the portion of the accident report automatically.

In some implementations, telematics devices 210 may provide the portion of the accident report (e.g., contact information, insurance information, etc.) to other telematics devices 210 associated with other vehicles involved in the accident. For example, an accident may involve a first vehicle (e.g., associated with a first telematics device 210-1) and a second vehicle (e.g., associated with a second telematics device 210-2). Based on determining that the vehicles are involved in the accident, first telematics device 210-1 and second telematics device 210-2 may exchange information associated with a driver of the first vehicle and/or a driver of the second vehicle (e.g., contact information, insurance information, etc.). In some implementations, first telematics device 210-1 and/or second telematics device 210-2 may provide the information to another device associated with the driver of the first vehicle and/or the driver of the second vehicle (e.g., user device 220, telematics server device 230, etc.). For example, first telematics device 210-1 and/or second telematics device 210-2 may provide the information (e.g., the contact information, the insurance information, etc.) to a device associated with the other driver (e.g., user device 220) via an email, an SMS text message, or the like.

In some implementations, telematics device 210 and/or user device 220 may cause another device (e.g., telematics server device 230, third party server device 240, etc.) to provide the information (e.g., the contact information, the insurance information, etc.) to one or more devices associated with other parties involved in the accident (e.g., other telematics devices 210, other user devices 220, etc.). For example, telematics server device 230 may determine contact information associated with a first driver of a first vehicle (e.g., based on first vehicle information). Based on the contact information (e.g., the driver's name, address, etc.), telematics server device 230 may query third party server device 240 (e.g., associated with an insurance provider) to receive insurance information associated with the driver. Based on receiving the insurance information, telematics server device 230 may provide the contact information and insurance information to one or more devices associated with other parties involved in the accident (e.g., other telematics devices 210, other user devices 220, other telematics server devices 230, etc.). Additionally, or alternatively, telematics server device 230 may provide the contact information to third party server device 240, and third party server device 240 may provide the insurance information to the one or more devices associated with the other parties (e.g., based on the contact information provided by telematics server device 230).

As further shown in FIG. 4, process 400 may include receiving a confirmation that the accident report is accurate based on providing the accident report for display (block 450). For example, telematics server device 230 may receive the confirmation from telematics device 210 and/or user device 220. In some implementations, the confirmation may act like and/or include a signature, and may indicate knowledge, approval, acceptance, and/or obligation of a person providing the confirmation (e.g., a driver, a passenger, a witness, etc.).

In some implementations, telematics device 210 may receive user input (e.g., via a user interface associated with a vehicle) from a user (e.g., a driver, a passenger, etc.) indicating that the accident report is accurate (e.g., indicating that the user accepts the accident report). Telematics device 210 may provide the user input to telematics server device 230. Additionally, or alternatively, user device 220 may receive user input (e.g., via a user interface) from a user indicating that the accident report is accurate, and user device 220 may provide the user input to telematics server device 230. In some implementations, the accident report may include inaccurate information, and the user may provide information correcting the inaccurate information to telematics server device 230 (e.g., via telematics device 210 and/or user device 220).

In some implementations, the user (e.g., of telematics device 210, of user device 220, etc.) may provide additional information to telematics server device 230 (e.g., via telematics device 210, user device 220, etc.). For example, the user may provide additional information (e.g., via user input to user device 220) that identifies a driver (e.g., a driver name, a driver address, a driver's license number, etc.), a passenger (e.g., a passenger name, a passenger address, etc.), an insurance company associated with the driver, or the like. In some implementations, the additional information may include information that identifies one or more injuries associated with one or more people involved in the accident. Additionally, or alternatively, the additional information may include information that identifies other vehicles associated with the accident, other drivers associated with the accident, other passengers associated with the accident, witnesses to the accident, or the like.

In some implementations, the additional information (e.g., information that identifies other vehicles, drivers, passengers, etc., associated with the accident) may be obtained by telematics devices 210 from another telematics device 210 (e.g., another telematics device 210 associated with another vehicle involved in the accident). Additionally, or alternatively, telematics device 210 may receive the additional information from telematics server device 230. For example, telematics device 210 may receive the additional information from telematics server device 230 if one or more drivers involved in an accident subscribe to a telematics services provider, or providers, that share information. Additionally, or alternatively, telematics device 210 may receive the additional information from one or more server devices (e.g., third party server devices 240) associated with one or more insurance companies.

In some implementations, the additional information may include a description of the accident. For example, the user may provide a description of the accident (e.g., a written description, a diagram, etc.) via user device 220, and user device 220 may provide the description to telematics server device 230.

In some implementations, the additional information may include one or more images of a scene of the accident (e.g., a photograph, a video, etc.). For example, user device 220 may capture a photograph of the vehicle (e.g., after the accident), and may provide the photograph to telematics server device 230. Additionally, or alternatively, the vehicle may be associated with one or more cameras (e.g., a dashboard camera, a back-up camera, etc.). Telematics device 210 may capture a photograph of one or more objects surrounding the vehicle (e.g., other vehicles, skid marks, etc.), and may provide the photograph to telematics server device 230.

In some implementations, the additional information may include vehicle information associated with other vehicles in the vicinity of the accident. For example, telematics server device 230 may receive images (e.g., pictures, video, etc.) captured by cameras associated with vehicles near the scene of the accident.

In some implementations, the additional information may include information that resolves discrepancies associated with the accident report (e.g., discrepancies between information associated with a first vehicle and information associated with a second vehicle). For example, based on determining that there are discrepancies associated with the accident report, telematics server device 230 may provide a notification to one or more user devices 220 (e.g., associated with one or more people involved in the accident). The notification may indicate that discrepancies exist, may identify the discrepancies, may identify a cause of the discrepancies, or the like. Additionally, or alternatively, the notification may invite a user of user device 220 to resolve the discrepancies (e.g., by reviewing the accident report, by reviewing the additional information provided by the user, by examining a scene of the accident, by examining vehicles involved in the accident, by speaking with other people associated with the accident, etc.). In some implementations, the user may provide corrected information (e.g., via user device 220) that corrects the discrepancies associated with the accident report.

As further shown in FIG. 4, process 400 may include outputting the accident report based on receiving the confirmation (block 460). For example, telematics server device 230 may provide the accident report to third party server device 240. Additionally, or alternatively, telematics server device 230 may provide the accident report to telematics device 210 and/or user device 220.

In some implementations, third party server device 240 may be associated with an insurance company, and telematics server device 230 may provide the accident report to third party server device 240 based on determining that the insurance company is associated with the vehicle. In some implementations, third party server device 240 may be associated with a law enforcement agency (e.g., police, highway patrol, etc.), and telematics server device 230 may provide the accident report to the law enforcement agency.

In some implementations, third party server device 240 may provide a notification to a device (e.g., a server device, a communication device, etc.) associated with a service provider (e.g., a tow truck provider, an emergency responder, etc.). For example, third party server device 240 may provide the notification to the device requesting that the service provider render aid to a user of the vehicle. In some implementations, third party server device 240 may provide the notification automatically (e.g., based on determining that the vehicle has been in the accident). In some implementations, third party server device 240 may provide the notification based on a request by a user (e.g., a driver of the vehicle, a passenger of the vehicle, etc.).

In some implementations, telematics server device 230 may receive a notification from the device associated with the service provider indicating that the service provider has dispatched the aid requested (e.g., has dispatched a tow truck, has dispatched an emergency responder, etc.). In some implementations, telematics server device 230 may notify telematics device 210 and/or user device 220 that the service provider has dispatched the aid requested.

In some implementations, the accident report may be associated with information received from multiple vehicles, and telematics server device 230 may provide the accident report (e.g., to third party server device 240) based on determining that there are not any significant discrepancies associated with the accident report. Additionally or alternatively, telematics server device 230 may receive multiple accident reports associated with an accident (e.g., a first accident report generated by a first telematics device 210-1 and/or a first user device 220-1, and a second accident report generated by a second telematics device 210-2 and/or a second user device 220-2), and may provide one or more of the accident reports (e.g., to third party server device 240) based on determining that the accident reports are similar (e.g., that no significant discrepancies exist between the first accident report and the second accident report).

Although FIG. 4 shows example blocks of process 400, in some implementations, process 400 may include additional blocks, fewer blocks, different blocks, and/or differently arranged blocks than those depicted in FIG. 4. Additionally, or alternatively, two or more of the blocks of process 400 may be performed in parallel.

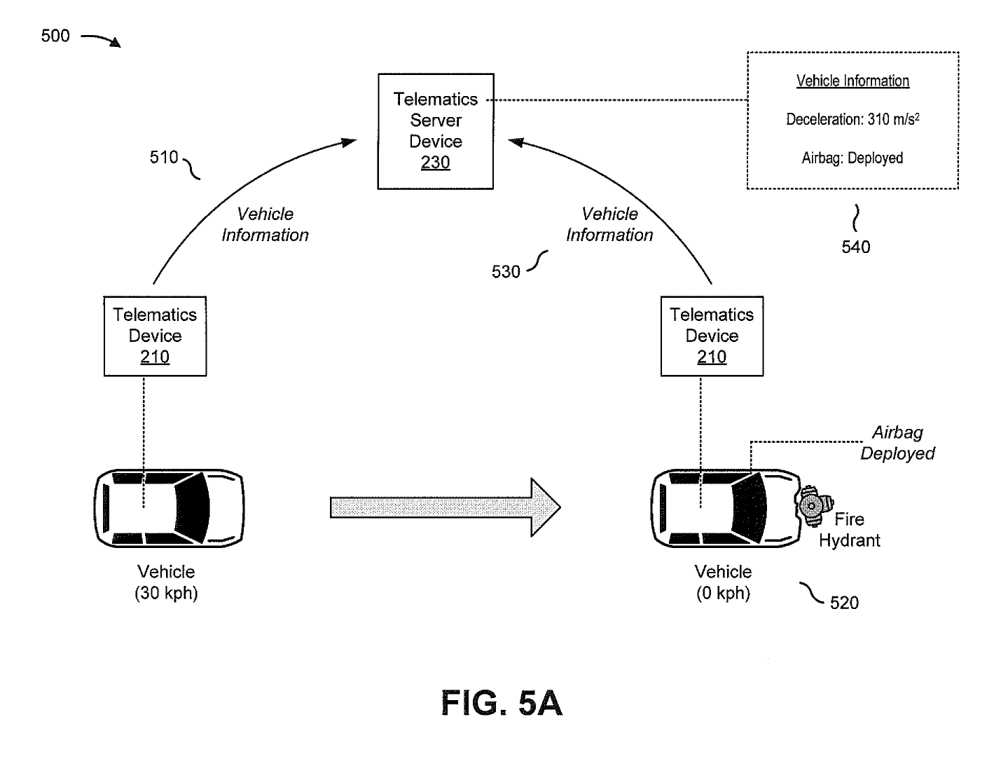

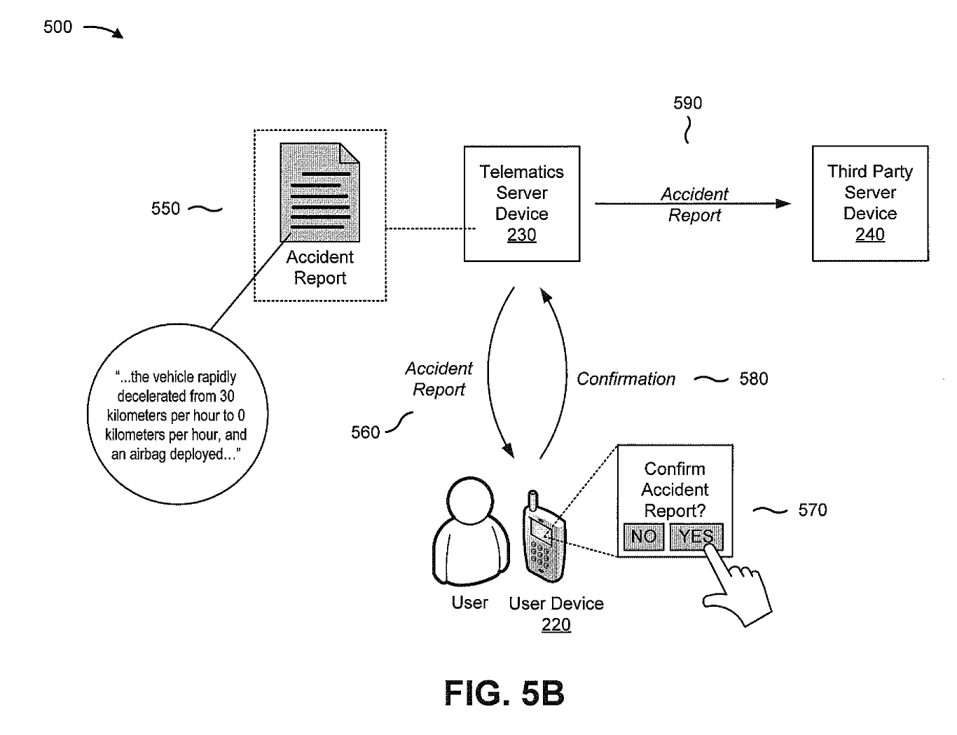

FIGS. 5A-5B are diagrams of an example implementation 500 relating to process 400 (FIG. 4). In example implementation 500, telematics server device 230 may determine that a vehicle, associated with telematics device 210, has collided with an object, and may generate an accident report based on vehicle information associated with the vehicle.

As shown in FIG. 5A, and by reference number 510, telematics server device 230 may receive vehicle information from telematics device 210. The vehicle information may include information that describes a state of the vehicle associated with telematics device 210, including information that identifies a first speed at which the vehicle is traveling (e.g., 30 km/h), a location of the vehicle, or the like.

As shown by reference number 520, assume that the vehicle collides with the object (e.g., a fire hydrant), and decelerates to a second speed (e.g., 0 km/h). Assume that an airbag associated with the vehicle deploys during the accident. As shown by reference number 530, telematics device 210 may continue to provide vehicle information (e.g., vehicle information associated with the accident).

As shown by reference number 540, telematics server device 230 may determine that the vehicle has experienced a deceleration (e.g., 310 m/s²) associated with changing speed from the first speed (e.g., 30 km/h) to the second speed (e.g., 0 km/h). Telematics server device 230 may determine that the deceleration is greater than a threshold deceleration (e.g., 100 m/s²). Telematics server device 230 may also determine that the airbag associated with the vehicle has deployed. Based on determining that the deceleration is greater than the threshold deceleration and based on determining that the airbag has deployed, telematics server device 230 may determine that the vehicle has been involved in an accident.

As shown in FIG. 5B, and by reference number 550, telematics server device 230 may generate an accident report based on the vehicle information. The accident report may include a narrative of the accident (e.g., “the vehicle rapidly decelerated from 30 kilometers per hour to 0 kilometers per hour, and an airbag deployed”). As shown by reference number 560, telematics server device 530 may provide the accident report to user device 220. A user of user device 220 (e.g., a driver of the vehicle) may view the accident report via a user interface associated with user device 220.

As shown by reference number 570, the user may provide user input (e.g., to user device 220) indicating that the accident report is accurate. User device 220 may provide the confirmation (e.g., the user input) to telematics server device 230, as shown by reference number 580. As shown by reference number 590, based on receiving the confirmation, telematics server device 230 may provide the accident report to third party server device 240 (e.g., associated with an insurance company).

As indicated above, FIGS. 5A-5B are provided merely as an example. Other examples are possible and may differ from what was described with regard to FIGS. 5A-5B.

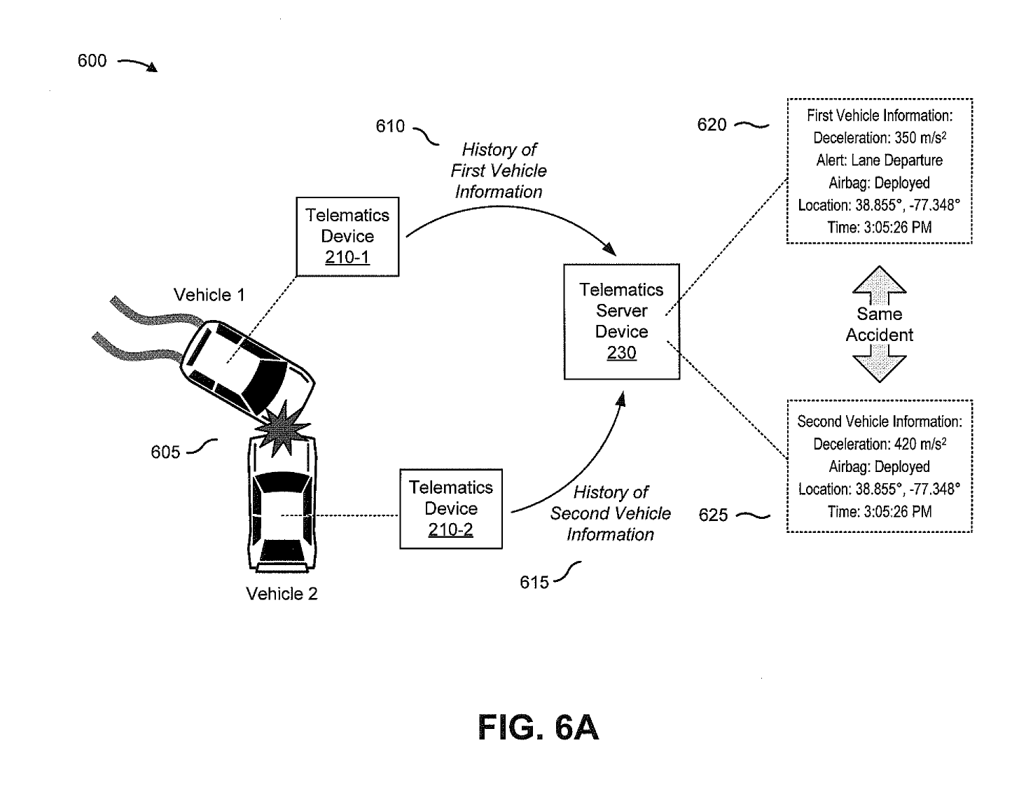

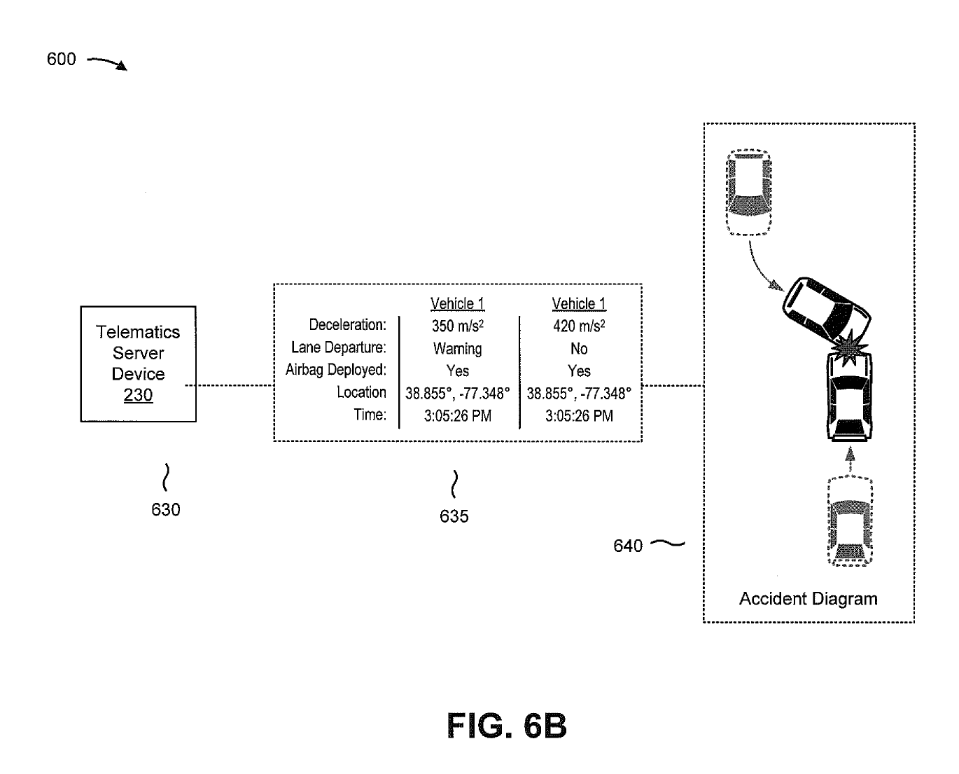

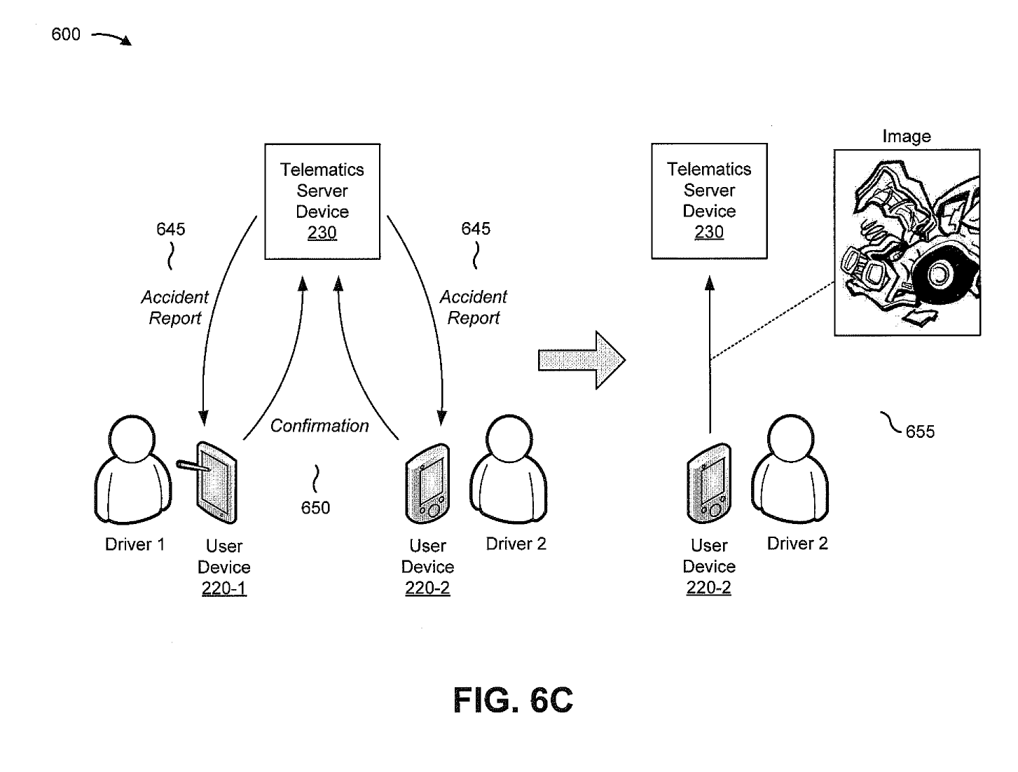

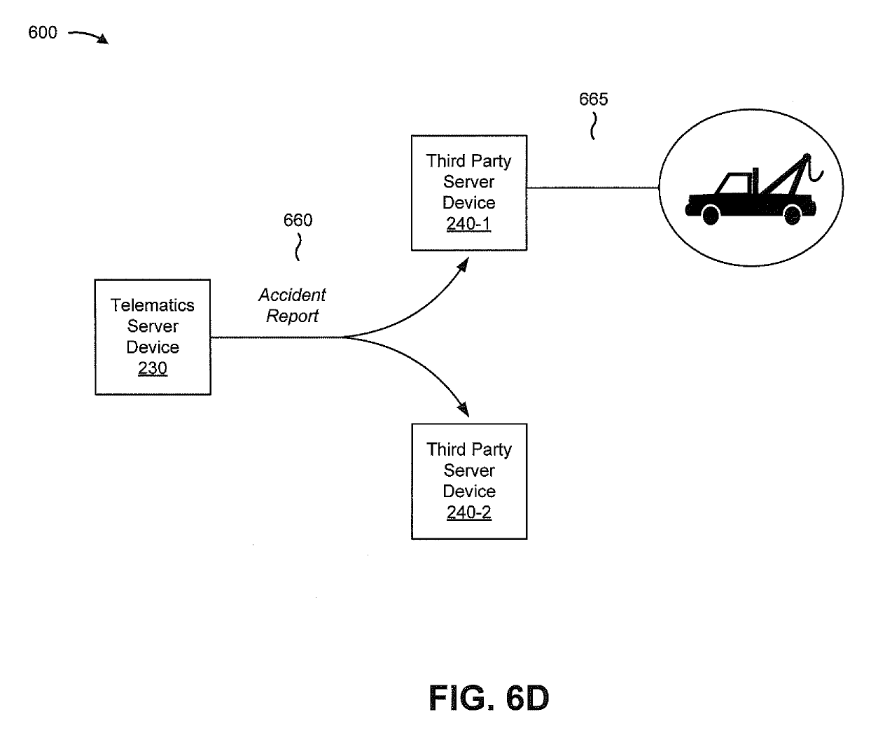

FIGS. 6A-6D are diagrams of another example implementation 600 relating to process 400 (FIG. 4). In example implementation 600, telematics server device 230 may determine that a first vehicle (e.g., associated with a first telematics device 210-1) and a second vehicle (e.g., associated with a second telematics device 210-2) are involved in an accident, and may generate an accident report associated with the first vehicle and the second vehicle.

As shown in FIG. 6A, and by reference number 605, assume that the first vehicle (e.g., “Vehicle 1”) and the second vehicle (e.g., “Vehicle 2”) are involved in an accident (e.g., a collision). First telematics device 210-1 may determine that the first vehicle is involved in the accident based on first vehicle information (e.g., based on determining that the first vehicle has experienced a deceleration greater than a threshold deceleration). Second telematics device 210-2 may determine that the second vehicle has been in the accident based on second vehicle information (e.g., based on determining that the second vehicle has experienced a deceleration greater than a threshold deceleration).

As shown by reference number 610, based on determining that the first vehicle has been in the accident, first telematics device 210-1 may provide a history of first vehicle information to telematics server device 230. The history of first vehicle information may include first vehicle information associated with a most recent period of time (e.g., 1 minute leading up to and including the accident). As shown by reference number 615, based on determining that the second vehicle has been in the accident, second telematics device 210-2 may provide a history of second vehicle information to telematics server device 230. The history of second vehicle information may include second vehicle information associated with the most recent period of time.

As shown by reference number 620, the first vehicle information may include information that identifies a deceleration (e.g., 350 m/s²), that a lane departure warning system alarmed, that an airbag deployed, coordinates associated with a geographic location (e.g., “38.855°, −77.348°”), and a time of the accident (e.g., “3:05:26 PM”). As shown by reference number 625, the second vehicle information may include information that identifies a deceleration (e.g., 420 m/s²), that an airbag deployed, coordinates associated with a geographic location (e.g., “38.855°, −77.348°”), and a time of the accident (e.g., “3:05:26 PM”). Telematics server device 230 may determine that the first vehicle and the second vehicle are associated with the same accident based on determining that the geographic location and time identified by the first vehicle information matches the geographic location and time identified by the second vehicle information.

As shown in FIG. 6B, and by reference number 630, telematics server device 230 may generate an accident report associated with the first vehicle and the second vehicle. As shown by reference number 635, the accident report may include first vehicle information and second vehicle information. As shown by reference number 640, telematics server device 230 may generate a diagram of the accident based on first vehicle information and second vehicle information (e.g., based on movements and locations of the first vehicle and the second vehicle), and may include the diagram in the accident report. The diagram may portray objects and/or events associated with the accident, and may include a mock-up, a visual rendering, an animated video, a simulation, or the like.

As shown in FIG. 6C, and by reference number 645, telematics server device 230 may provide the accident report to a first user device 220-1 (e.g., associated with a first driver of the first vehicle) and a second user device 220-2 (e.g., associated with a second driver of the second vehicle). First user device 220-1 may display the accident report on a user interface associated with first user device 220-1, and second user device 220-2 may display the accident report on a user interface associated with second user device 220-2. The first driver may provide user input (via the user interface associated with first user device 220-1), and the second driver may provide user input (e.g., via the user interface associated with second user device 220-2), indicating that the accident report is accurate. As shown by reference number 650, telematics server device 230 may receive the user input from first user device 220-1 and second user device 220-2. As shown by reference number 655, second user device 220-2 may capture an image of the second vehicle, and may provide the image to telematics server device 230.

As shown in FIG. 6D, and by reference number 660, telematics server device 230 may provide the accident report to a first third party server device 240-1 (e.g., associated with an insurance company associated with the first vehicle) and to a second third party server device 240-2 (e.g., associated with an insurance company associated with the second vehicle). As shown by reference number 665, first third party server device 240-1 may determine that a tow truck is needed at the scene of the accident based on the first vehicle information (e.g., based on determining that the first vehicle deployed airbags), and may provide a notification to a tow truck provider requesting that the tow truck provider dispatch a tow truck to the scene of the accident.

As indicated above, FIGS. 6A-6D are provided merely as an example. Other examples are possible and may differ from what was described with regard to FIGS. 6A-6D.

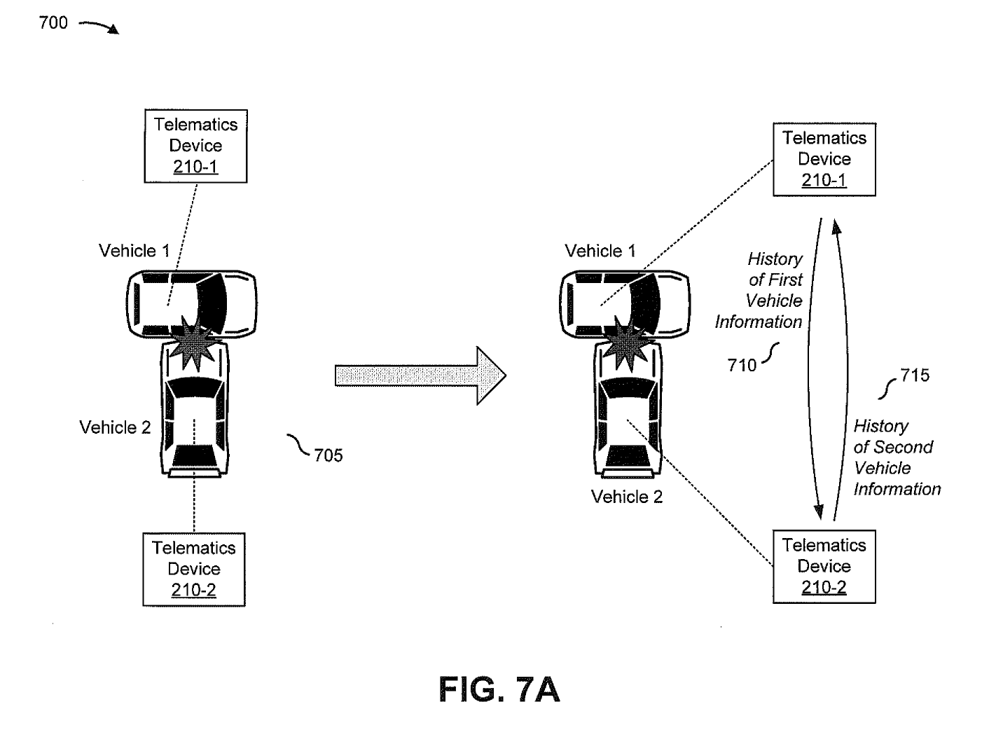

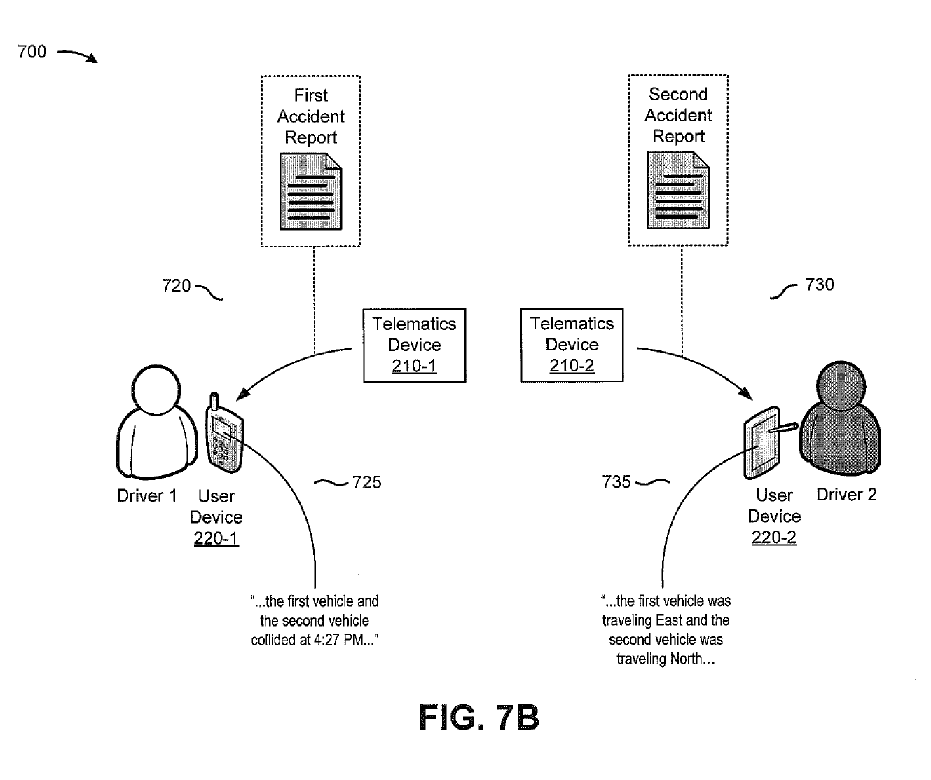

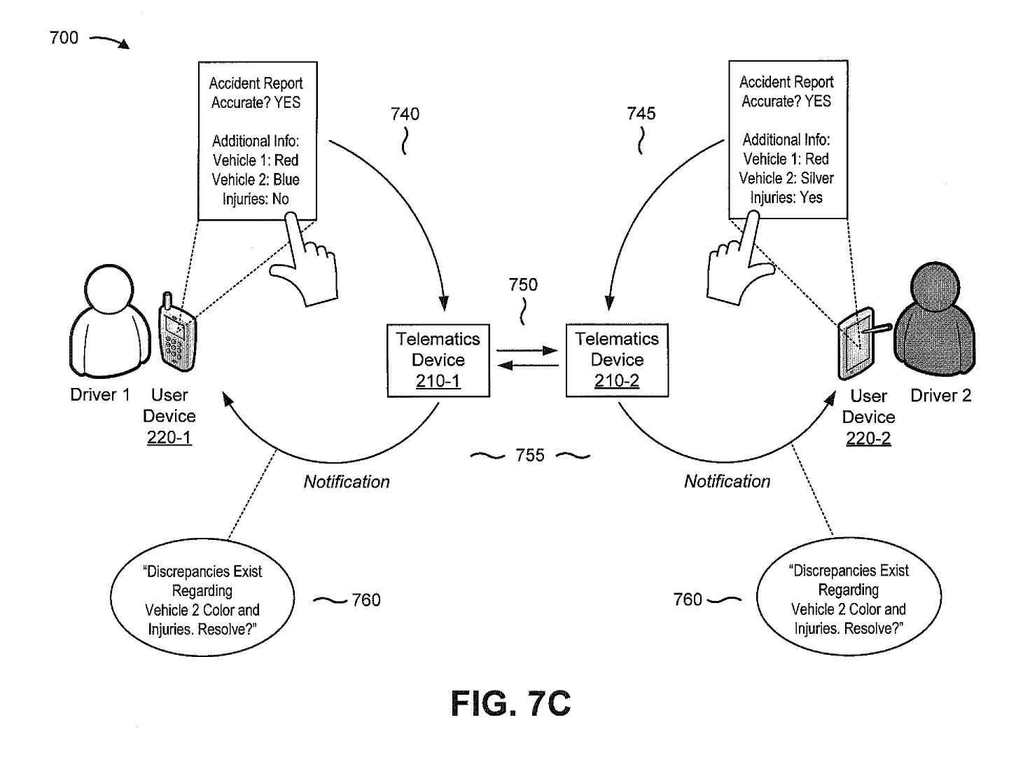

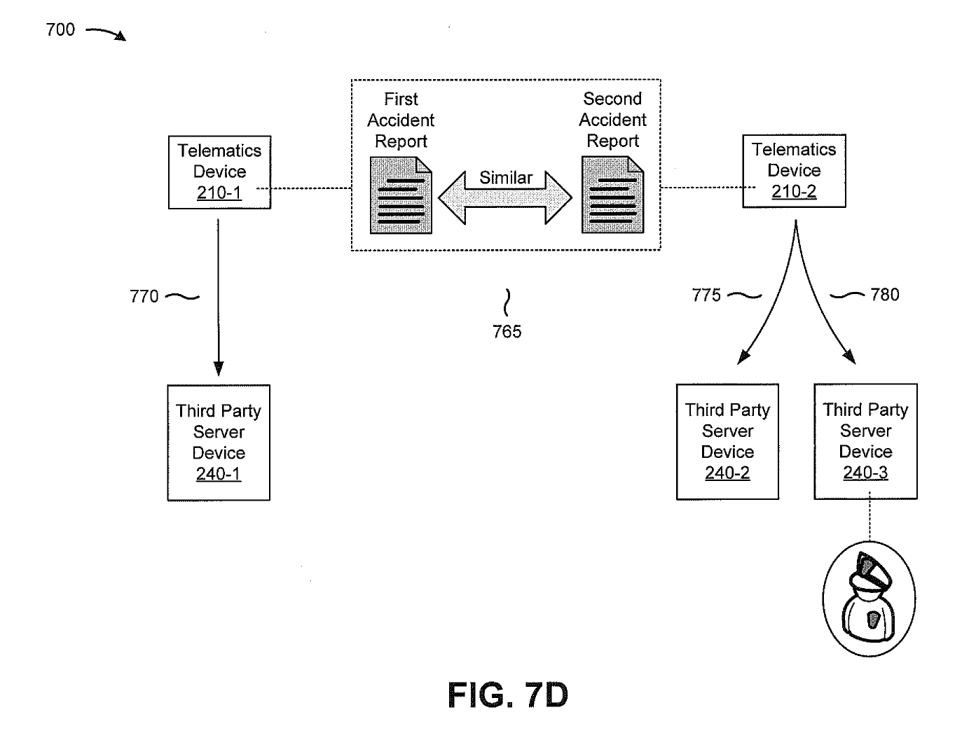

FIGS. 7A-7D are diagrams of yet another example implementation 700 relating to process 400 (FIG. 4). In example implementation 700, assume that a first vehicle (e.g., associated with a first telematics device 210-1) collides with a second vehicle (e.g., associated with second telematics device 210-2). Based on determining that the first vehicle and the second vehicle have been in an accident, first telematics device 210-1 and second telematics device 210-2 may exchange vehicle information associated with the first vehicle and the second vehicle, and may generate accident reports based on the vehicle information.

As shown in FIG. 7A, and by reference number 705, first telematics device 210-1 may determine that the first vehicle has been in accident (e.g., based on determining that an airbag associated with the first vehicle has deployed). Likewise, second telematics device 210-2 may determine that the second vehicle has been in the accident (e.g., based on determining that the second vehicle is associated with a deceleration greater than a threshold deceleration).

As shown by reference number 710, first telematics device 210-1 may provide a history of first vehicle information to second telematics device 210-2 (e.g., via a wireless connection). The history of first vehicle information may include vehicle information associated with the first vehicle for a most recent period of time (e.g., a 5 minute period of time leading up to and including the accident). As shown by reference number 715, second telematics device 210-2 may provide a history of second vehicle information to first telematics device 210-1 (e.g., via the wireless connection). The history of second vehicle information may include vehicle information associated with the second vehicle for the period of time.

As shown in FIG. 7B, and by reference number 720, first telematics device 210 may generate a first accident report based on the history of first vehicle information and the history of second vehicle information. The first accident report may include a narrative that describes events associated with the first vehicle and the second vehicle during and preceding the accident. First telematics device 210-1 may provide the first accident report to a first user device 220-1 associated with a driver of the first vehicle (e.g., “Driver 1”). First user device 220-1 may display the first accident report, as shown by reference number 725.

As shown by reference number 730, second telematics device 210-2 may generate a second accident report based on the history of first vehicle information and the history of second vehicle information. The second accident report may include a narrative that describes events associated with the first vehicle and the second vehicle during and preceding the accident. Second telematics device 210-2 may provide the second accident report to a second user device 220-2 associated with a driver of the second vehicle (e.g., “Driver 2”). Second user device 220-2 may display the second accident report, as shown by reference number 735.

As shown in FIG. 7C, and by reference number 740, the driver of the first vehicle may provide (e.g., via first user device 220) a confirmation to first telematics device 210-1 indicating that the first accident report is accurate. The driver of the first vehicle may also provide additional information associated with the accident, such as a color of the first vehicle (e.g., “Red”), a color of the second vehicle (e.g., “Blue”) and whether any parties were injured (e.g., “No”). As shown by reference number 745, the driver of the second vehicle may provide (e.g., via second user device 220-2) a confirmation to second telematics device 210-2 indicating that the second accident report is accurate. The driver of the second vehicle may also provide additional information associated with the accident, such as a color of the first vehicle (e.g., “Red”), a color of the second vehicle (e.g., “Silver”), and whether any parties were injured (e.g., “Yes).

As shown by reference number 750, first telematics device 210-1 and second telematics device 210-2 may exchange the additional information received from first user device 220-1 and second user device 220-2. Based on the additional information, first telematics device 210-1 and second telematics device 210-2 may determine that there are discrepancies associated with the additional information. The discrepancies may be due to the driver of the first vehicle providing additional information (e.g., that the second vehicle is blue and that no parties were injured in the accident) that differs from the additional information provided by the driver of the second vehicle (e.g., that the second vehicle is silver and that a party was injured in the accident).

As shown by reference number 755, based on determining that there are discrepancies associated with the additional information, first telematics device 210-1 may send a notification to first user device 220-1, and second telematics device 210-2 may send a notification to second user device 220-2. As shown by reference number 760, the notification may indicate that discrepancies exists, and may request additional information to resolve the discrepancies. Based on the notification, the driver of the first vehicle may provide corrected information that resolves the discrepancies (e.g., that indicates that the second vehicle is silver and that a party was injured in the accident).

As shown in FIG. 7D, and by reference number 765, first telematics device 210-1 and second telematics device 210-2 may determine that the first accident report (e.g., that includes the addition information provided by the driver of the first vehicle and the corrected information provided by the driver of the first vehicle) and the second accident report (e.g., that includes the additional information provided by the driver of the second vehicle) are similar (e.g., that the there are no longer any substantial discrepancies between the first accident report and the second accident report).

As shown by reference number 770, based on determining that the first accident report and the second accident report are similar, first telematics device 210-1 may provide the first accident report to a third party server device 240-1 associated with an insurance company that insures the first vehicle. As shown by reference number 775, based on determining that the first accident report and the second accident report are similar, second telematics device 210-2 may provide the second accident report to a third party server device 240-2 associated with an insurance company that insures the second vehicle. Second telematics device 210-2 may also provide the second accident report to a third party server device 240-3 associated with a police station, as shown by reference number 780.

As indicated above, FIGS. 7A-7D are provided merely as an example. Other examples are possible and may differ from what was described with regard to FIGS. 7A-7D. For example, resolving differences in first and second accident reports in step 765 may occur at a server remote from vehicles associated with telematics devices 210-1 and 210-2. Additionally, or alternatively, if drivers involved in an accident determine that they do not need to create an official accident report for forwarding to law enforcement authorities, they may nevertheless exchange contact information and insurance information. This may occur directly from one device to another (e.g., telematics device 210, user device 220, etc.). Additionally, or alternatively, a request from one driver's device may authorize release of information (e.g., contact information, insurance information, etc.) from a third party server (e.g., third party server device 240) that includes such information to a designated device, address (e.g., email address, internet protocol (“IP”) address, etc.), and/or server associated with the other driver.

Implementations described herein may allow a telematics server device to automatically determine that a vehicle has been involved in an accident and generate an accident report based on vehicle information associated with the vehicle.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on capabilities and/or specifications associated with a device on which the user interfaces are displayed, or a set of configurations based on capabilities and/or specifications associated with a device on which the user interfaces are displayed.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive vehicle information associated with a vehicle;
determine that the vehicle has been in an accident based on the vehicle information,
the accident including a collision of the vehicle with an object;
generate an accident report based on determining that the vehicle has been in the accident and based on the vehicle information;
provide the accident report for display;
receive a confirmation that the accident report is accurate based on providing the accident report for display; and
output the accident report based on receiving the confirmation.

2. The device of claim 1, where the one or more processors, when outputting the accident report, are further to:
provide the accident report to a server device associated with an insurance company.

3. The device of claim 1, where the one or more processors, when providing the accident report based on receiving the confirmation, are further to:
provide the accident report to a server device associated with a law enforcement agency.

4. The device of claim 1, where the vehicle information is first vehicle information;
where the vehicle is a first vehicle;
where the one or more processors, when receiving the first vehicle information, are further to:
receive second vehicle information associated with a second vehicle;
where the one or more processors, when determining that the first vehicle has been in the accident, are further to:
determine that the accident is associated with the second vehicle based on the second vehicle information; and
where the one or more processors, when generating the accident report, are further to:
generate the accident report associated with the first vehicle and the second vehicle based on the first vehicle information and the second vehicle information.

5. The device of claim 4, where the one or more processors, when receiving the confirmation, are further to:
receive a confirmation associated with a first user of the first vehicle; and
receive a confirmation associated with a second user of the second vehicle.

6. The device of claim 4, where the one or more processors, when generating the accident report, are further to:
determine a discrepancy between the first vehicle information and the second vehicle information;
where the one or more processors, when providing the accident report for display, are further to:
provide a notification identifying the discrepancy; and
where the one or more processors, when receiving the confirmation, are further to:
receive information correcting the discrepancy.

7. The device of claim 1, where the one or more processors, when outputting the accident report, are further to:
provide the accident report to a server device, associated with an insurance company, to cause the server device to provide a notification to a device associated with a service provider,
the notification including a request for the service provider to render aid to a user of the vehicle; and
where the one or more processors are further to:
receive an indication from the server device that the service provider has dispatched aid to the user.

8. The device of claim 1, where the one or more processors, when outputting the accident report, are further to:
determine a service provider associated with the vehicle; and
provide a notification to a device associated with the service provider,
the notification including a request for the service provider to render aid to a user of the vehicle.

9. A computer-readable medium storing instructions, the instructions comprising:
one or more instructions that, when executed by one or more processors, cause the one or more processors to:
receive vehicle information associated with a vehicle;
determine that the vehicle has been involved in a collision based on the vehicle information,
generate an accident report based on determining that the vehicle has been in the collision and based on the vehicle information;
provide the accident report for display to a user of the vehicle;
receive a confirmation from a user device, associated with the user, that the accident report is accurate based on providing the accident report for display; and
output the accident report based on receiving the confirmation.

10. The computer-readable medium of claim 9, where the one or more instructions, that cause the one or more processors to output the accident report, further cause the one or more processors to:
provide the accident report to a server device, associated with an insurance company, to cause the server device to dispatch a service provider to render aid to a user of the vehicle; and
where the one or more instructions, when executed by the one or more processors, further cause the one or more processors to:
receive a notification from the server device indicating that the service provider has been dispatched.

11. The computer readable medium of claim 10, where the one or more instructions, when executed by the one or more processors, further cause the one or more processors to:
receive a confirmation from the user device indicating that the user requests the aid associated with the service provider.

12. The computer-readable medium of claim 9, where the one or more instructions, that cause the one or more processors to receive the vehicle information associated with the vehicle, further cause the one or more processors to:
receive video captured by a camera associated with the vehicle,
the camera being configured to capture video of an object in front of, behind, or to a side of the vehicle.

13. The computer-readable medium of claim 9, where the accident report includes a narrative of events associated with the accident.

14. The computer-readable medium of claim 9, where the one more instructions, that cause the one or more processors to receive the confirmation, further cause the one or more processors to:
receive information that identifies an insurance company associated with the user; and
where the one or more instructions, the cause the one or more processors to output the accident report, further cause the one or more processors to:
provide the accident report to a server device, associated with the insurance company, based on the information that identifies the insurance company.

15. A method, comprising:
receiving, by a device, vehicle information associated with a vehicle;
determining, by the device, that the vehicle has been in an accident based on the vehicle information;
generating, by the device, an accident report based on determining that the vehicle has been in the accident and based on the vehicle information;
providing, by the device, the accident report for display;
receiving, by the device, a confirmation that the accident report is accurate based on providing the accident report for display; and
outputting, by the device, the accident report based on receiving the confirmation.

16. The method of claim 15, where the vehicle is a first vehicle;
where the accident report is a first accident report;
where generating the first accident report further comprises:
receiving a second accident report associated with a second vehicle involved in the accident;
determining that there are no substantial discrepancies between the first accident report and the second accident report; and
where outputting the accident report further comprises:
outputting the accident report based on determining that there are no substantial discrepancies between the first accident report and the second accident report.

17. The method of claim 15, where receiving the confirmation further comprises:
receiving a statement associated with a user of the vehicle; and
where outputting the accident report further comprises:
providing the statement.

18. The method of claim 15, where receiving the confirmation further comprises:
receiving an image captured by a user device associated with a user of the vehicle; and
where outputting the accident report further comprises:
providing the image.

19. The method of claim 15, where generating the accident report further comprises:
generating a diagram of events associated with the accident based on the vehicle information;
where providing the accident report for display further comprises:
providing the diagram; and
where outputting the accident report further comprises:
providing the diagram.

20. The method of claim 15, where generating the accident report further comprises:
generating a simulation of events associated with the accident based on the vehicle information;
where providing the accident report for display further comprises:
providing the simulation; and
where outputting the accident report further comprises:
providing the simulation.
